(19) United States
(12) Patent Application Publication
(10) Pub. No.: US 2009/0231860 A1
(43) Pub. Date: Sep. 17, 2009

(54) Lamp reflector structure

(75) Inventor: Tsan-Jung Chen, Sanchong City (TW)

Correspondence Address: BACON & THOMAS, PLLC, 625 SLATERS LANE, FOURTH FLOOR, ALEXANDRIA, VA, 22314-1176, US

(73) Assignee: KOCAM INTERNATIONAL CO., LTD., Sanchong City (TW)

(21) Appl. No.: 12/153,196

(22) Filed: May 15, 2008

(30) Foreign Application Priority Data
Mar. 14, 2008 (TW) 097204393

(51) Int. Cl. F21V 7/00

(52) U.S. Cl. 362/341

(57) ABSTRACT

A lamp reflector structure includes a metal hood, an adhesive layer and a reflecting plate. The structure is applied to a backlight module of a liquid crystal display, and the metal hood is made by bending a metal plate into a first cross-sectional shape and forms a containing space in the metal hood and dents on the reflecting plate, such that the reflecting plate can be bent to a position corresponding to the dents and into a second cross-sectional shape. A portion of the reflecting plate not corresponding to the dents is attached into the containing space through the adhesive layer, and each bent position of the metal hood is disposed proximate to each dent of the reflecting plate. The reflecting plate is thinner at positions corresponding to the dents, but the remaining portion maintains an even thickness to enhance the reflection index of the lamp reflector structure.

### FIELD OF THE INVENTION

The present invention relates to a lamp reflector structure, and more particularly to a lamp reflector structure applied in a backlight module of a liquid crystal display (LCD) and capable of maintaining an even thickness to enhance the reflection index of a lamp reflector.

### BACKGROUND OF THE INVENTION

In general, a traditional display product such as a television and a monitor adopts a cathode ray tube (CRT) to achieve the purpose of displaying images, but the CRT display usually has the issues of a heavy weight and a high power consumption, and thus the traditional CRT display product is replaced gradually by a liquid crystal display (LCD) panel as the high-tech industry advances. Compared with CRT products, LCD panel products such as televisions, monitors and notebook computers come with a light, thin, short and compact design, and thus users not only can move the LCD products easily, but also can set the LCD products without occupying too much space. The LCD products can improve the utility of space effectively and become favorable products to individuals and corporate users, and LCD products are used extensively in our daily life and at work.

In a general method of displaying images by an LCD panel, light is entered from the bottom of a liquid crystal to a liquid crystal layer, and transmitted through the liquid crystal. Since the liquid crystal is a non-luminescent material, the LCD panel requires a backlight module to project the light upward to provide a light source with sufficient brightness and uniform distribution for displaying the images normally. Therefore, the quality of a lamp reflector that operates with the backlight module is one of the factors to determine the quality of the LCD panel. Most traditional lamp reflectors are manufactured by stamping and shaping processes as shown in FIG. 1, and operators usually place a work piece 1 of the lamp reflector at an edge at the top of a bending platform 20 of a stamping machine 2, and a shaping device 21 of the stamping machine 2 is moved towards the bending platform 20 to stamp the work piece 1 with a desired cross-sectional shape. In FIG. 1, the work piece 1 is comprised of a metal plate 10, an adhesive layer 12, a reflecting plate 14 and a protecting film 16, wherein the reflecting plate 14 is made of a white foamed polyethylene terephthalate (PET) plastic material, or coated with a layer of light reflecting paint on one of the surfaces of the transparent PET material to serve as a reflecting light source. In the description below, the transparent PET material plus the reflecting plate 14 composed of a light reflecting paint are used for the illustration. A lateral side of the metal plate 10 is coupled to another lateral side of the reflecting plate 14 that is not coated by the light reflecting paint through the adhesive layer 12, and the protecting film 16 is attached onto a lateral side of the reflecting plate 14 by an adhesive at the back of the protecting film 16 for preventing the light reflecting paint from being rubbed or damaged by a manufacturing knife tool during the stamping process or preventing any adverse affection to the light reflection. Thus, manufacturers can produce a finished good of the lamp reflector by stamping the work piece 1 during the stamping process.

Since the metal plate 10 comes with a hardness greater than the hardness of the reflecting plate 14, a larger force is required to be applied to the shaping device 21 to stamp the work piece 1 into a predetermined cross-sectional shape as shown in FIGS. 1 and 2, and the shaping device 21 requires a larger force to bend the metal plate 10 into the required cross-sectional shape, such that during the process of bending the metal plate 10, a deforming stress will be produced at a bent position (as shown by the dotted circle in FIG. 2) of the reflecting plate by an action exerted on the shaping device 21 (as indicated by the arrowhead in FIG. 2), and the bent position of the reflecting plate 14 will be deformed by the deforming stress (as indicated by the arrowhead in FIG. 2) produced by the metal plate 10, and the thickness at the bent position will become thinner. If the lamp reflector is applied to a backlight module of a liquid crystal display, light will penetrate through the bent position of the reflecting plate 14 easily to lower the overall reflection index of the lamp reflector. If the bent position of the reflecting plate 14 is deformed, the bent position or the surface proximate to the bent position will be extended or compressed, and the light reflecting paint of the reflecting plate 14 will become uneven or damaged, and thus an adverse effect will be imposed to the reflection index of the product.

In general, the shape of the lamp reflector usually complies with the shape of the LCD panel casing, and various different models of the panel casings are developed to meet the increasingly higher design requirements. Unlike a monotonous cubic or rectangular shape for the traditional casings, the lamp reflector is stamped into a cross-sectional shape with several bent portions to meet the functions of the casing, so that the thickness at each position of the lamp reflector will be uneven, and the number of thinner positions is increased, and such phenomena seriously affect the yield rate of the products. Referring to FIG. 2, if the lamp reflector is installed in the panel casing, a light tube 23 is placed into the lamp reflector and coupled with a light guide member 25 at a position proximate to the edge of the lamp reflector, so that a light source enters into the light guide member 25, and no action takes place at the connecting position (as indicated by the dotted circle D in FIG. 2) of the reflecting plate 14 and the light guide member 25, and thus incurring a higher cost to manufacturers. Referring to FIG. 3, a fixing base 24 is disposed separately on both ends of the light tube 23 (only one of the fixing bases 24 is shown in FIG. 3 for simplicity), such that the light tube 23 can be fixed into the lamp reflector, and the fixing base 24 can be connected to the reflecting plate 14, but a portion of the reflecting plate 14 cannot function properly. Since the reflecting plate 14 is isolated, the heat dissipating effect of the lamp reflector will be reduced and the interior of the lamp reflector will be overheated to expedite the ageing of components in the lamp reflector. Therefore, finding a way of developing a novel lamp reflector structure to overcome the foregoing shortcomings of the prior art demands immediate attentions and feasible solutions.

### SUMMARY OF THE INVENTION

In view of the shortcomings of the traditional lamp reflector structure having a thinner portion produced at a bent position of a reflecting plate during a stamping process, the inventor of the present invention based on years of experience in the related industry to conduct extensive researches and experiments, and finally developed a lamp reflector structure in accordance with the present invention to overcome the foregoing shortcomings of the prior art.

Therefore, it is a primary objective of the present invention to provide a lamp reflector structure, comprising a metal hood, an adhesive layer and a reflecting plate, and the lamp reflector structure is applied to a backlight module of a liquid crystal display, wherein the metal hood is made by bending a metal plate into a first cross-sectional shape, and forms a containing space on the internal side of the metal hood and a plurality of dents on a lateral side of the reflecting plate, such that the reflecting plate can be bent to a position corresponding to each dent and into a second cross-sectional shape, and a portion of the reflecting plate not corresponding to the dents is attached into the containing space through the adhesive layer, and each bent position of the metal hood is disposed proximate to each dent of the reflecting plate. Since the reflecting plate corresponds to the position of each dent has a thinner thickness, the remaining portion can still maintain an even thickness and a flat surface, therefore the invention can overcome the shortcomings of a traditional reflecting plate stamped on a lamp reflector having an uneven thickness, so as to enhance the reflection index of the lamp reflector structure.

Another objective of the present invention is to provide a lamp reflector structure that attaches the reflecting plate into a containing space with a cross-sectional shape similar to the metal hood. In other words, the first cross-sectional shape can be one not identical to the second cross-sectional shape, so that the reflecting plate can be attached into any containing space with a cross-sectional shape similar to the metal hood. Manufacturers can mass produce the reflecting plates and quickly connect the metal hood with the reflecting plate without requiring the traditional manufacturing method that attaches the reflecting plate before stamping the metal plate into a predetermined cross-sectional shape, and thus the invention improves the efficiency of manufacturing the lamp reflector structure and strengthens the capability of modularizing the lamp reflector structure for the manufacture effectively.

A further objective of the present invention is to provide a lamp reflector structure, such that manufacturers can estimate the connecting position of the lamp reflector structure and the light guide member in advance and remove the non-functioning portion the reflecting plate, so that the light guide member can be connected directly to the metal hood to save the waste of materials of the reflecting plate and lower the manufacturing cost effectively.

Another objective of the present invention is to provide a lamp reflector structure, such that manufacturers can estimate the position of installing a fixing base of both ends of the light tube in the lamp reflector structure, and the fixing base can be connected directly to the metal hood. The present invention not only saves the material of the reflecting plate, but also improves the heat dissipating effect by keeping the fixing base in a direct contact with the metal hood, so as to prevent components from being aged and extend the life expectancy of the panel of the lamp reflector structure effectively.

To make it easier for our examiner to understand the shape, structure, design principle and performance of the present invention, we use preferred embodiments together with the attached drawings for the detailed description of the invention as follows:

### BRIEF DESCRIPTION OF THE DRAWINGS

FIG. 1 is a schematic view of manufacturing a traditional lamp reflector;

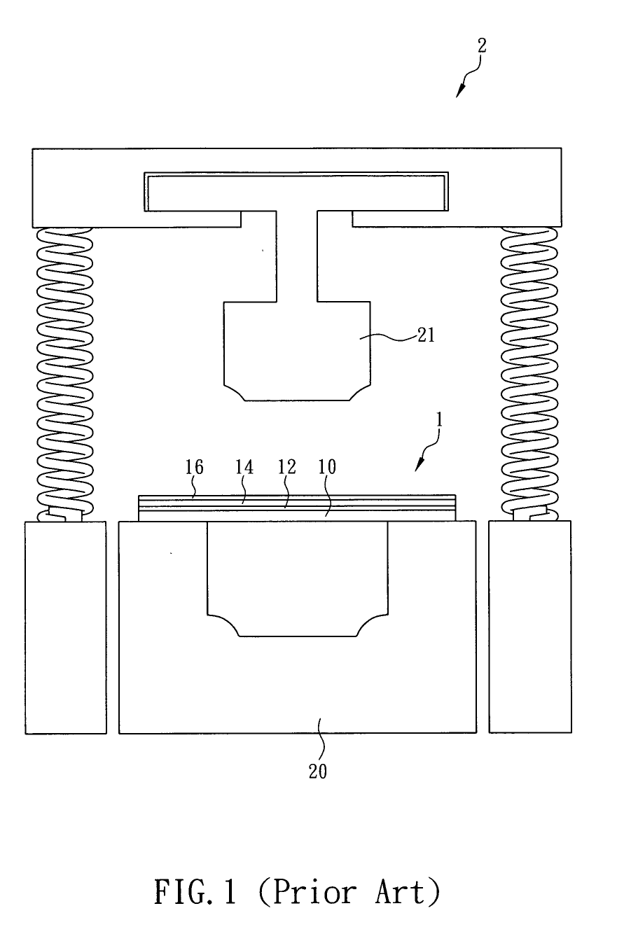

FIG. 2 is a schematic view of an application of a traditional lamp reflector;

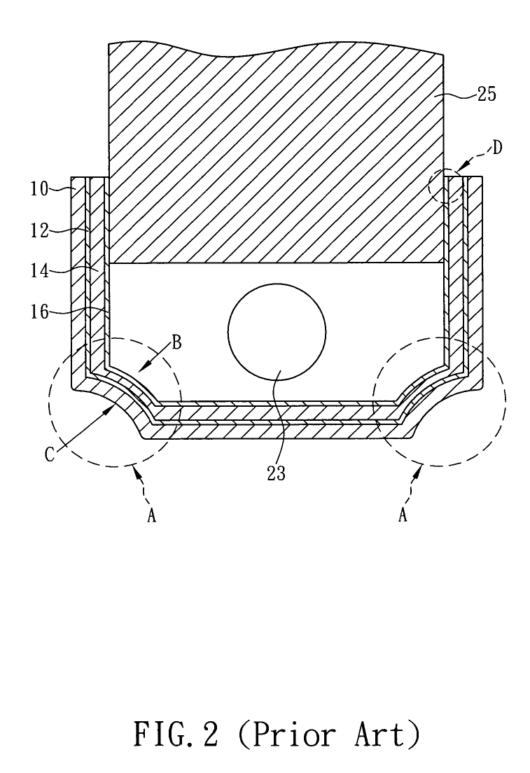

FIG. 3 is a schematic view of another application of a traditional lamp reflector;

FIG. 4 shows a first preferred embodiment of the present invention;

FIG. 5 shows a second preferred embodiment of the present invention; and

FIG. 6 shows a third preferred embodiment of the present invention.

### DETAILED DESCRIPTION OF THE PREFERRED EMBODIMENTS

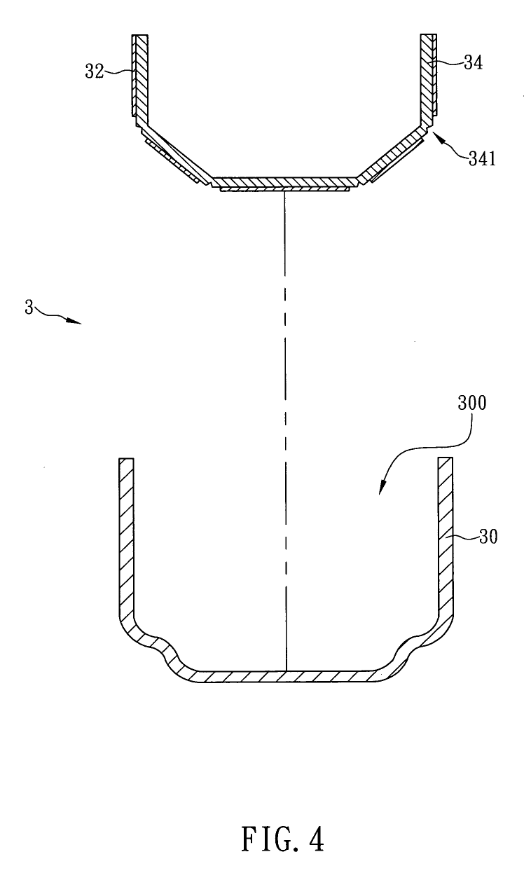

Referring to FIG. 4 for a lamp reflector structure applied in a backlight module of a liquid crystal display (LCD) in accordance with the present invention, the lamp reflector structure 3 comprises a metal hood 30, an adhesive layer 32 and a reflecting plate 34, wherein the metal hood 30 has a first cross-sectional shape, and the reflecting plate 34 includes a plurality of dents 341 disposed on a lateral side of the reflecting plate 34. The portion corresponding to the dents 341 can be bent, such that the reflecting plate 34 is formed into a second cross-sectional shape, and the reflecting plate 34 is attached into the containing space 300 through the adhesive layer 32, and each bent position of the metal hood 30 is proximate to the dent 341 of the reflecting plate 34.

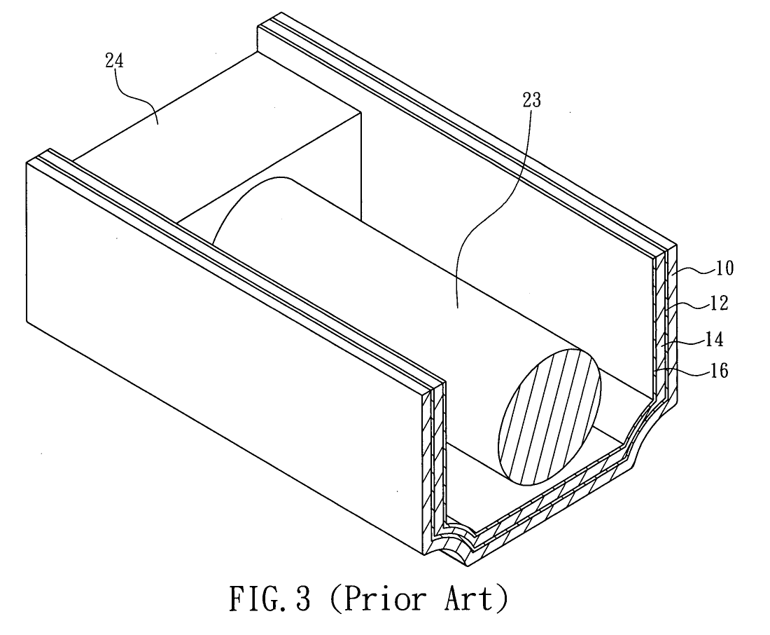

Referring to FIG. 4 for a preferred embodiment of the present invention, a lamp reflector structure 3 comprises a metal hood 30, an adhesive layer 32 and a reflecting plate 34, wherein the metal hood 30 is formed by stamping and bending a metal plate into a first cross-sectional shape, and the first cross-sectional shape is stamped according to the shape of a panel casing (not shown in the figure) installed in the lamp reflector structure 3. In the preferred embodiment, the metal hood 30 is stamped as shown in FIG. 3. A containing space 300 is formed on the internal side of the metal hood 30, so that manufacturers can install the reflecting plate 34 into the containing space 300, and the reflecting plate 34 includes four dents 341 disposed on a lateral side of the reflecting plate 34. The positions of the reflecting plate 34 corresponding to the dents 341 can be bent, such that the reflecting plate 34 forms a second cross-sectional shape (as shown in FIG. 4), the cross-sectional shape of the reflecting plate 34 second can be accommodated into the containing space 300 of the metal hood 30, and the portion of the reflecting plate 34 not corresponding to the dents 341 is attached onto the metal hood 30 through the adhesive layer 32 and fixed into the containing space 300, and each bent position of the metal hood 30 is proximate to each dent 341. In other words, the reflecting plate 34 includes a lateral side of the dent 341 aligned in a direction towards the metal hood 30 to form the lamp reflector structure 3 in accordance with the present invention. The reflecting plate 34 has a thinner thickness at positions corresponding to the dents 341 to facilitate a precise bending of the reflecting plate 34, and the remaining portion can remain an even thickness. Unlike the traditional lamp reflector, the lamp reflector structure 3 of the invention has a large area of the portion with a thinner thickness produced on the reflecting plate after the reflecting plate goes through the stamping process, so that the lamp reflector structure 3 of the invention can maintain a good reflection index. It is noteworthy to point out that the reflecting plate 34 is made of a white foamed polyethylene terephthalate (PET) plastic material or a transparent PET material, and one of its lateral sides is coated with a light reflecting paint, and thus the present invention can use a knife mould to create a dent 341 on the reflecting plate 34, and another lateral side opposite to the dents 341 is a side of the reflecting plate 34 having the function of a reflecting light source. During the manufacturing process of the dents 341, the light reflecting effect of the reflecting plate 34 will not be ruined, and the surface of the reflecting plate 34 having the function of a reflecting light source can be maintained flat, so as to greatly improve the yield rate of manufacturing the lamp reflector structure 3.

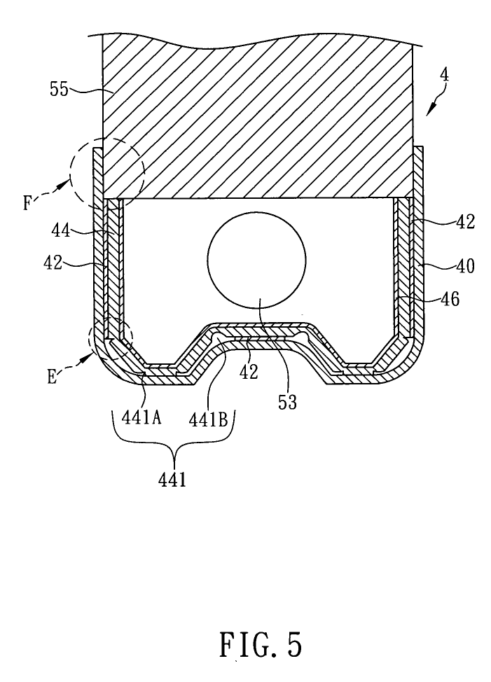

Referring to FIG. 5 for another preferred embodiment of the present invention, a metal hood 40 is stamped into a first cross-sectional shape (as shown in FIG. 5), and a reflecting plate 44 includes eight dents 441 disposed on a lateral side of reflecting plate 44, and the bent positions corresponding to the dents 441, such that the reflecting plate 44 form a second cross-sectional shape, and the position of the reflecting plate 44 not corresponding to the dents 441 is connected to the metal hood 40 through an adhesive layer 42, wherein the adhesive layer 42 can be a double-sided adhesive, a hot melt adhesive or any other adhesive material, and each bent position of the metal hood 40 is disposed proximate to each dent 441 (as indicated by the dotted circle E in FIG. 5) of the reflecting plate 44 to form the lamp reflector structure 4 of the present invention. In FIG. 5, the dents 441 of the reflecting plate 44 in accordance with another preferred embodiment of the invention are formed by a knife of a knife mould (which is the shaper edge of the knife) as shown by 441A in FIG. 5, or stamped by a K knife in the knife mould (which is the more obtuse edge of the knife) as indicated by 441B in FIG. 5. Regardless of the aforementioned ways, the dent of the invention refers to any dent 441 formed on the reflecting plate 44 and provided for bending the reflecting plate 44 into the second cross-sectional shape. After the lamp reflector structure 4 of the invention creates a cross-sectional shape for the metal hood 40 and the reflecting plate 44, the metal hood 40 and the reflecting plate 44 are coupled, so that a predetermined distance (as shown by the dotted circle in FIG. 5) is formed between an edge of the metal hood 40 and an edge of the reflecting plate 44. Therefore, manufacturers can compute the connecting position of a light guide plate 55 and the lamp reflector structure 4 and install a light tube 53 in the lamp reflector structure 4 when the lamp reflector structure 4 is assembled into the panel casing, and connect the lamp reflector structure 4 with the light guide plate 55. Now, the light guide plate 55 can be coupled directly with the metal hood 40, not only saving the material cost of the reflecting plate 44, but also preventing any portion of the reflecting plate 44 from not functioning or avoiding a waste of the reflecting plate 44. In actual practices of the invention, manufacturers further coat a protecting film 46 onto a side of a light reflecting paint of the reflecting plate 44 to prevent the light reflecting paint from being scratched by workers during transportation or adversely affecting the reflection index of the lamp reflector structure 4, so as to extend the life expectancy of the lamp reflector structure 4.

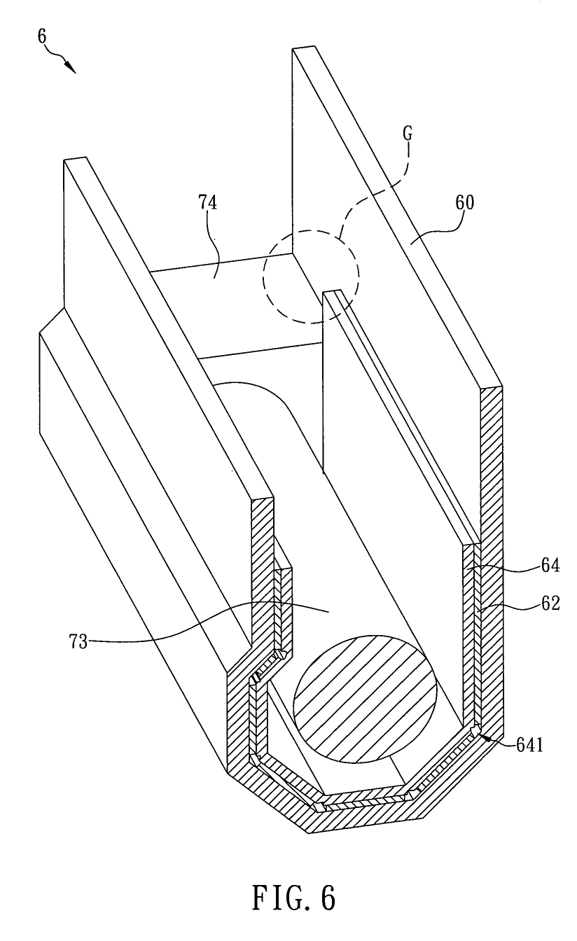

Referring to FIG. 6 for another preferred embodiment of the present invention, a metal hood 60 is stamped into a first cross-sectional shape (as indicated by 6 in FIG. 6), a reflecting plate 64 is bent into a second cross-sectional shape (as indicated by 64 in FIG. 6) through the dents 641 of the reflecting plate 64, and the position of the reflecting plate 64 not corresponding to the dents 641 is attached into the containing space of the metal hood 60 through an adhesive layer 62. Further, a light tube 73 is installed in the lamp reflector structure 6, and a fixing base 74 is disposed separately on both ends of the light tube 73 (for simplicity, only one fixing base 74 is shown in FIG. 6) and the fixing base 74 is connected directly with the metal hood 60 (as indicated by the dotted circle G in FIG. 6), so that the heat produced by the light tube 73 can be dissipated to the metal hood 60 through the fixing base 74. Therefore, manufacturers can estimate the connecting position of the fixing base 74 and the metal hood 60 to save the material of the reflecting plate 64 and increase the heat dissipating effect of the lamp reflector structure 6.

It is noteworthy to point out that the lamp reflector structure of the invention includes a metal hood and a reflecting plate, both with a cross-sectional shape, so that the reflecting plate can be attached into a containing space of the metal hood with the similar cross-sectional shape. In other words, the first cross-sectional shape can be a shape not identical to the second cross-sectional shape to improve the capability of modularizing the lamp reflector structure. Obviously, such structure has the following advantages:

1. Since the reflecting plate uses its dents for the bending procedure, the invention can improve the traditional way of stamping and forming the reflecting plate of the lamp reflector, and overcome the issues of an uneven thickness and a too-large area at the thinner positions. The invention can improve the reflection index of the lamp reflector structure.

2. Since the metal hood and the reflecting plate are manufactured separately, and the reflecting plate can be attached into the containing space of the metal hood with a similar cross-sectional shape instead of being limited by a metal hood with the same cross-sectional shape, therefore manufacturers can mass produce the reflecting plate in advance, and then connect the reflecting plate onto the metal hood with the similar cross-sectional shape, so as to improve the capability of modularizing the lamp reflector structure and the manufacturing efficiency.

3. Manufacturers can compute the connecting position of a light guide plate with the lamp reflector structure, and connect the light guide plate directly with the metal hood to save costs and prevent a portion of the reflecting plate from not functioning or wasting a portion of the reflecting plate.

4. Manufacturers can connect the fixing base on both ends of the light tube directly with the metal hood, not only saving the material of the reflecting plate and lowering the manufacturing cost effectively, but also enhancing the heat dissipating effect of the lamp reflector structure. The invention can prevent overheat and ageing of components in the lamp reflector structure, and extend the life expectancy of the panel products effectively.

The present invention has been described with the preferred embodiment thereof and it is understood that many changes and modifications to the described embodiment can be carried out without departing from the scope and the spirit of the invention that is intended to be limited only by the appended claims.

What is claimed is:

1. A lamp reflector structure, applied in a backlight module of a liquid crystal display, comprising:
a metal hood, formed by bending a metal plate into a first cross-sectional shape, and having a containing space defined therein;
a reflecting plate, having a plurality of dents disposed on a side of the reflecting plate, and a portion of the reflecting plate corresponding to the dents being bendable to form a second cross-sectional shape of the reflecting plate; and
an adhesive layer, adhered onto the reflecting plate at a position not corresponding to the dents, and adhered onto a side of the metal hood proximate to the containing space, such that when the reflecting plate is coupled into the containing space of the metal hood through the adhesive layer, each bent position of the metal hood is proximate to each dent.

2. The lamp reflector structure of claim 1, wherein the metal hood comes with an edge having a predetermined distance from an end of the reflecting plate.

3. The lamp reflector structure of claim 2, wherein the first cross-sectional shape of the metal lamp reflector is identical to the second cross-sectional shape of the reflecting plate.

4. The lamp reflector structure of claim 2, wherein the first cross-sectional shape of the metal lamp reflector is not identical to the second cross-sectional shape of the reflecting plate.

5. The lamp reflector structure of claim 3, wherein the reflecting plate has a protecting film disposed on another side of reflecting plate opposite to the dents.

6. The lamp reflector structure of claim 4, wherein the reflecting plate has a protecting film disposed on another side of reflecting plate opposite to the dents.
